(19) United States
(12) Patent Application Publication
(10) Pub. No.: US 2025/0214595 A1
(43) Pub. Date: Jul. 3, 2025

(54) CONTEXTUAL COMMUNICATION SYSTEM

(71) Applicant: GM Global Technology Operations LLC, Detroit, MI (US)

(72) Inventors: Russell A. Patenaude, Macomb Township, MI (US); Jason G. Heitman, Livonia, MI (US); Curtis L. Hay, Petoskey, MI (US)

(73) Assignee: GM Global Technology Operations LLC, Detroit, MI (US)

(21) Appl. No.: 18/400,713

(22) Filed: Dec. 29, 2023

(51) Int. Cl. B60W 50/00

(52) U.S. Cl. CPC B60W 50/00; B60W 2050/0019; B60W 2556/55; B60W 2756/00

(57) ABSTRACT

A contextual communication system includes an external device including a communication receiver and an electronic control unit (ECU). The ECU includes data processing hardware and memory hardware that stores actions and action settings. The data processing hardware includes a contextual communication feature that has a telematics system configured to detect the external device and a contextual event. The contextual communication feature is configured to selectively issue a contextual alert based on the detected external device and in response to the contextual event.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a contextual communication system.

Vehicles are often used in combination with third party devices. While some third party devices, such as mobile devices, may have access to geographic data, many devices used in combination with vehicles are not equipped with systems capable of independently monitoring geographic data. Thus, a user may be required to implement manual adjustments to these devices. Alternatively, a user may forego utilizing features that require manual adjustment or implementation due to the potential inconvenience of execution of the actions by the user or as a result of overlooking the step of manual activation.

### SUMMARY

In some aspects, a contextual communication system includes an external device including a communication receiver and an electronic control unit (ECU). The ECU includes data processing hardware and memory hardware that stores actions and action settings. The data processing hardware includes a contextual communication feature that has a telematics system configured to detect the external device and a contextual event. The contextual communication feature is configured to selectively issue a contextual alert based on the detected external device and in response to the contextual event.

In some examples, the actions may be associated with the external device and the contextual communication feature may be configured to execute the actions based on contextual event data corresponding to the detected contextual event. Optionally, the action settings stored in the memory hardware may include automatic settings and manual settings, and each action may be configured with one of the automatic settings and the manual settings. The contextual communication feature may be configured to automatically execute the actions configured with the automatic settings in response to the detected contextual event. In some instances, the contextual communication feature may be configured to issue an action notification associated with actions configured with the manual settings.

In some examples, the telematics system may include a geographic application and a geofence. The contextual communication feature may be configured to detect the communication receiver of the external device using at least one of the geographic application and the geofence. In some instances, the ECU may be configured with direct access to the external device to execute at least one of the actions in response to the detected contextual event. Optionally, the telematics system may be configured to detect the external device via the communication receiver. The contextual communication feature may be configured to utilize contextual event data corresponding to the contextual event to execute at least one action associated with the detected external device. A vehicle may include the contextual communication system.

In other aspects, a contextual communication system for a vehicle includes an external device including a communication receiver configured to share a connectivity status of the external device. Memory hardware stores actions and action settings including at least one of automatic settings and manual settings. A geographic application is configured to detect a location of the vehicle. Data processing hardware is communicatively coupled with the memory hardware and the geographic application and includes a contextual communication feature. The contextual communication feature is configured to detect a contextual event and includes a telematics system communicatively coupled with the geographic application. The telematics system is configured to detect the connection status of the external device, and the contextual communication feature is configured to selectively execute one or more of the actions in response to the detected connectivity status of the external device and the contextual event.

In some examples, the contextual communication feature may be configured to execute the actions based on contextual event data corresponding to the detected contextual event. The contextual event data may include one or more of a time of day, the location of the vehicle, a heading of the vehicle, and a speed of the vehicle. The contextual communication feature may be configured to issue an action notification associated with the actions configured with the manual settings and may be configured to execute the one or more actions in response to an input at the action notification. The contextual communication feature may be configured to issue a reminder associated with the automatic settings in response to the detected contextual event. Optionally, the contextual communication feature may be configured to automatically execute at least one of the one or more actions based on the location of the vehicle from the geographic application.

In some instances, the data processing hardware may be configured with direct access to the external device to execute at least one of the one or more actions. Optionally, the external device may be configured with a multi-function use, and the contextual communication feature may be configured to utilize contextual event data corresponding to the detected contextual event to execute at least one of the one or more actions based on the multi-function use of the external device. The contextual communication feature may be configured to utilize the telematics system to cooperate with the geographic application to identify an action associated with the multi-function use. A vehicle may include the contextual communication system.

In further aspects, a system includes at least one external device including a communication receiver configured for sharing data of the at least one external device, a user device, and a vehicle including an electronic control unit (ECU). The ECU is communicatively coupled to the communication receiver of the at least one external device and the user device. The ECU includes a contextual communication feature that is configured to detect a contextual event and is configured to execute an action in response to the detected contextual event. The user device is configured to receive a contextual alert from the contextual communication feature in response to the contextual event associated with the action.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle and external devices of a contextual communication system according to the present disclosure;

FIG. 2 is an enlarged partial perspective view of an interior of a vehicle with an action notification according to the present disclosure displayed on an infotainment display:

FIG. 3 is a schematic block diagram of a contextual communication system according to the present disclosure:

FIG. 4 is an example flow diagram for a contextual communication system according to the present disclosure:

FIG. 5 is another example flow diagram for a contextual communication system according to the present disclosure; and

FIG. 6 is an example flow diagram for the contextual communication system of FIG. 5.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second.” “third.” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code.” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application.” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

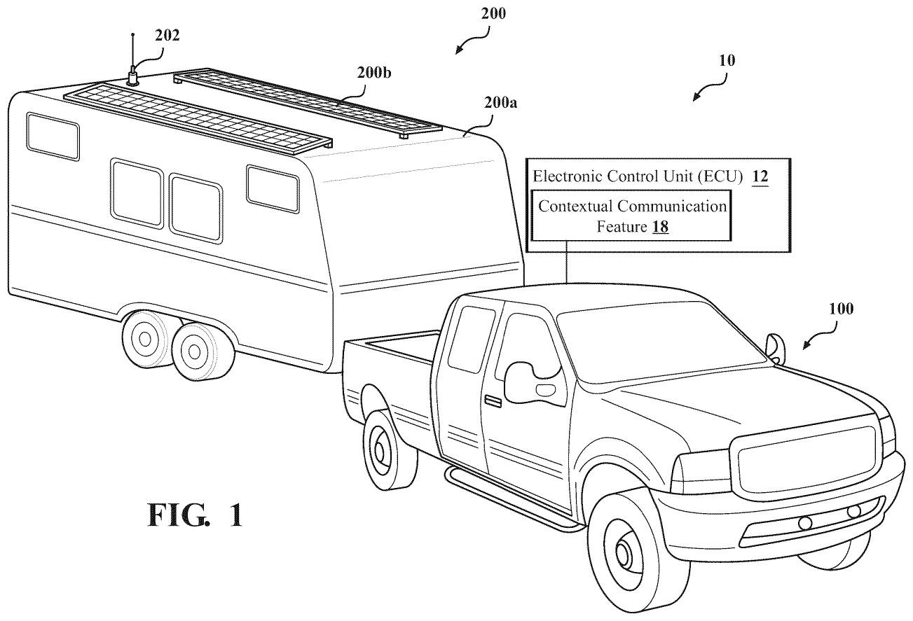

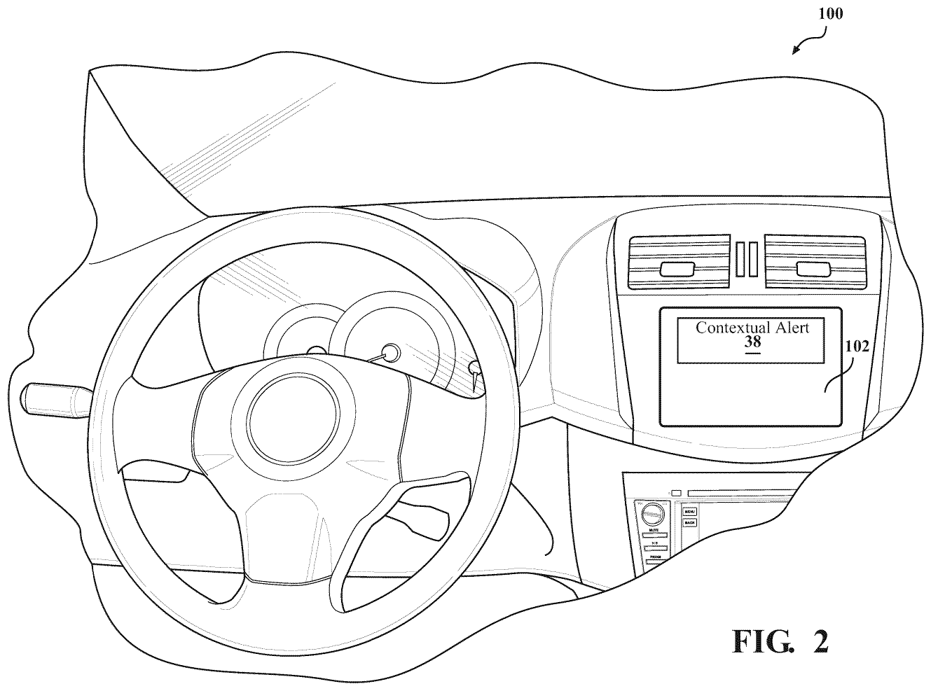

Referring to FIGS. 1-3, a contextual communication system 10 is configured to interconnect a vehicle 100 and at least one external device 200. The external device 200 may include, but is not limited to, a trailer, solar panels, a tonneau, lighting devices, and any other external device or feature that may be operated via the contextual communication system 10. For example, FIG. 1 illustrates a trailer 200a equipped with solar panels 200b. The external device(s) 200 are described in more detail below. While the contextual communication system 10 is described with respect to the vehicle 100 and the external device 200, it is contemplated that the contextual communication system 10 may include a user device 300 that can communicate with the external device(s) 200.

For example, the user device 300 may be a mobile device equipped with the features described herein with respect to the vehicle 100. Additionally or alternatively, the user device 300 may be utilized in combination with the vehicle 100 to receive inputs 302 from a user, as described in more detail below: The vehicle 100 includes an infotainment display 102 that may also receive inputs 302 from the user. The inputs 302, as described herein, generally correspond with a selection and/or execution by the user with respect to the contextual communication system 10.

The vehicle 100 includes an electronic control unit (ECU) 12 configured with data processing hardware 14 and memory hardware 16. As described in more detail herein, the data processing hardware 14 includes a contextual communication feature 18 that cooperates as part of the contextual communication system 10 to communicate with a communication receiver 202 of the external device 200. The contextual communication feature 18 is configured to detect a contextual event 20 and store contextual event data 22. The contextual event data 22 includes, but is not limited to, a time of day 24, a location 26, heading 28, and/or speed 30 of the vehicle 100. In addition to the contextual events 20 described above, the contextual events 20 may also include off-board events, such as arrival at a predetermined destination and a point of interest that may correlate with one or more external devices 200. The contextual event data 22 may be gathered or otherwise identified and monitored by a telematics system 32 of the contextual communication feature 18. The telematics system 32 is configured to detect the external device(s) 200 and the contextual event 20. Further, the telematics system 32 monitors the location 26 of the vehicle 100 and receives updated location information with respect to any detected external devices 200.

The telematics system 32 may include a geographic application 34 that may be utilized to monitor the location 26 of the vehicle 100. It is contemplated that the geographic application 34 may be selectively deactivated by the user. Thus, if the telematics system 32 is unable to identify the location 26 of the vehicle 100, then the contextual communication feature 18 may prompt the user that a current location 26 is unavailable. The contextual communication feature 18 may subsequently prompt the user to activate the geographic application 34 by authorizing location sharing.

The telematics system 32 may also be utilized by the contextual communication system 10 to monitor any detected external device(s) 200. For example, the telematics system 32 may detect the external device(s) 200 and determine a connectivity status of the detected external device 200. The telematics system 32 is communicatively coupled with the communication receiver 202 of the external device 200. Thus, the telematics system 32 also receives and monitors the location and movement status of the external device 200. The geographic application 34 of the telematics system 32 may define a geofence 36 relative to the vehicle 100 and the detected external device 200. The geofence 36 assists in tracking the contextual event data 22 relative to the vehicle 100 and the external device 200. For example, the contextual communication feature 18 is configured to detect the communication receiver 202 of the external device 200 using at least one of the geographic application 34 and the geofence 36.

The telematics system 32 assists the contextual communication feature 18 in identifying the contextual events 20. For example, the contextual communication feature 18 may selectively issue a contextual alert 38 in response to the contextual event data 22 and based on the detected external device 200, which may include selections for the user with respect to the external device 200 based on the contextual event 20. The telematics system 32 may also assist the contextual communication feature 18 in identifying actions 40 for the vehicle 100 and/or the external device 200 based on the contextual event 20. The actions 40 may be associated with the external device(s) 200, and the contextual communication feature 18 may be configured to execute the actions 40 based on the contextual event data 22. For example, the telematics system 32 may be utilized to identify relative positioning data 42 for the external device 200 based on the geofence 36, as described in more detail below. The relative positioning data 42 may include, but is not limited to, channel sounding, ultra wideband, and/or Bluetooth® low energy anchors for providing orientation and remote adjustments.

Referring still to FIGS. 1-3, the contextual communication feature 18, before executing an action 40, may issue the contextual alert 38 in response to the contextual event 20. The contextual alert 38 may be displayed on the infotainment display 102 of the vehicle 100 and/or a display 304 of the user device 300. The ECU 12 may receive the input 302 indicating a selection in response to the contextual alert 38, described in more detail below. The contextual alert 38 is associated with one or more actions 40 that may be executed by the contextual communication system 10. In some examples, the actions 40 may be executed by the contextual communication system 10 without the contextual communication feature 18 issuing the contextual alert 38. For example, certain actions 40 may be programmed as part of the contextual communication system 10 to proceed in response to the associated contextual event 20.

The actions 40 may be stored in the memory hardware 16 and may have respective action settings 44. The actions 40 may be associated with the external device 200, such that the ECU 12 may select an action 40 from the one or more actions 40 to execute based on the contextual event data 22. The actions 40 are configured with the action settings 44, which include automatic settings 46 and manual settings 48. The action settings 44 define whether an action notification 50 associated with actions 40 configured with manual settings 48 is issued by the contextual communication feature 18 in response to the contextual event 20. For example, the contextual communication system 18 is configured to issue the action notification 50 when the action 40 associated with the detected contextual event 20 has a manual setting 48. The manual setting 48 of the action 40 is defined as the ECU 12 receiving an input 302 from the user before executing the action 40. Certain actions 40 may be preset or have a default manual setting 48.

The action settings 44 may be set by a user of the contextual communication system 10 and/or may be set by a manufacturer. The action settings 44 may be adjusted or otherwise altered by the user to personalize user preferences. In some instances, the action settings 44 may be altered by the user, such that some action settings 44 may be altered between automatic settings 46 and manual settings 48 depending on the user preferences. Additionally or alternatively, the action settings 44 for the respective actions 40 may be set by the manufacturer to maximize efficiency of the vehicle 100. In some examples, the automatic settings 46 may be associated with a light emitting diode (LED) lighting device 200, such that the automatic activation of the LED lighting device 200 may be negligible with respect to the efficiency of the vehicle 100.

The contextual communication feature 18 is configured to automatically execute the actions 40 configured with the automatic settings 46 in response to the detected contextual event 20. The contextual communication feature 18 may also issue a reminder 52 associated with actions 40 configured with the automatic settings 46. The reminder 52 may provide an option to the user to change the action settings 44 associated with the respective automatic action 40 from the automatic settings 46 to the manual settings 48. The reminder 52 may be dismissed by the user, and the ECU 12 may be configured to stop issuing reminders 52 after a predetermined number of dismissals by the user.

Referring still to FIGS. 1-3, each action 40 is associated with the contextual event 20 detected by the contextual communication feature 18, such that the contextual communication feature 18 may prompt the user with actions 40 that are determined to be associated with the contextual event 20 and the external device(s) 200 based on the contextual event data 22. The contextual event 20 may be determined, at least in part, by the telematics system 32 via the geographic application 34, as mentioned above. The geographic application 34 is configured detect the location 26 of the vehicle 100 and share, via the telematics system 32, the location and other relevant contextual event data 22 with the external device 200. The contextual communication feature 18 may also share with the external device 200 the contextual event data 22 associated with the speed 30 and the heading 28 of the vehicle 100 as well as the time of day 24 during which the vehicle 100 is operational. For example, the contextual communication feature 18 may communicate the time of day 24 and location 26 with an external LED lighting device 200, which may activate in response to the contextual event data 22 provided. The contextual event data 22 may be shared with the external device 200 using short range wireless. In some examples, the short range wireless may include, but is not limited to, Bluetooth R. The ECU 12 determines whether sharing is available with the external device 200 and determines the type of external device 200 that is connected with the contextual communication system 10.

As noted above, the external devices 200 may include a range of devices that are separate from but capable of communication with the ECU 12. For example, the memory hardware 16 may include stored devices 60 that includes the external device(s) 200. The ECU 12 may determine which of the stored devices 60 is detected with the contextual communication system 10 via detection by the telematics system 32. For example, the telematics system 32 may utilize the geofence 36 to identify the communication receiver 202 of a respective external device 200. In some instances, a single communication receiver 202 may be utilized for multiple external devices 200.

For example, the solar panels 200b illustrated in FIG. 1 are disposed on the trailer 200a. In this example, the solar panels 200b may utilize the same communication receiver 202 as the trailer 200a. Thus, the telematics system 32 may identify both the trailer 200a and the solar panels 200b via the communication receiver 202. Additionally or alternatively, each external device 200 may have a distinct communication receiver 202, and the telematics system 32 may differentiate the detected external device using the geofence 36 and the respective communication receiver 202. The telematics system 32 is configured to receive a connection signal 204 from the communication receiver 202, which is used by the telematics system 32 to detect a connectivity status 204a of the external device 200. The contextual communication feature 18 is configured to selectively execute one or more of the actions in response to the detected connectivity status 204a of the external device 200 and the contextual event 20.

The geofence 36 of the telematics system 32 may also be utilized as the contextual event 20, such that the telematics system 32 may detect that the external device 200 and/or the vehicle 100 is within the geofence 36 defined by the ECU 12. In response, the contextual communication feature 18 may determine whether to execute an action 40 or proceed with issuing a contextual alert 38 depending on the contextual configuration of the external device 200. The communication receiver 202 may generally be utilized for identifying the external device 200 and any associated external devices 200. The communication receiver 202 may indicate to the telematics system 32 which external devices 200 are currently active and/or connected with the vehicle 100. As mentioned above, the memory hardware 16 may store stored devices 60 that may be associated with the detected external devices 200. The memory hardware 16 may associate and store actions 40 and contextual events 20 with the stored devices 60. Thus, the contextual communication feature 18 may readily identify an action 40 based on the contextual event 20 and detected external device 200.

The stored devices 60) may include active and/or connected external devices 200, as well as inactive or disconnected external devices 200. As noted above, the communication may be via a short range wired or wireless connection between the ECU 12 and the external device(s) 200. For example, the external devices 200 may have a multi-function use, such as a trailer and/or recreational vehicle (RV) in which the location 26 and time of day 24 may be advantageous data points for operation of the external device 200. The contextual communication feature 18 is configured to utilize the contextual event data 22 corresponding to the detected contextual event 20 to execute at least one of the actions 40 based on the multi-function use of the external device 200. The contextual communication feature 18 utilizes the telematics system 32 in cooperation with the geographic application 34 to identify an action 40 associated with the multi-function use of the external device 200. Further, in this example, the ECU 12 via the contextual communication feature 18 may provide global positioning system (GPS) data, as part of the contextual event data 22, to the external device(s) 200, such as satellite antenna, for the external device 200 to auto-locate satellite locations. Satellite dishes may be auto-tuned using the relative positioning data 42 received from the contextual communication feature 18, via the telematics system 32.

In other examples, the external device 200 may have a single function, such as a low energy connection. One non-limiting example of a low energy connection of an external device 200 may include a solar panel or satellite that may be selectively repositioned to maximize functionality. For example, the contextual communication feature 18, via the telematics system 32, may provide the solar panels 200b with the contextual event data 22, so the solar panels 200b may track the position of the sun and account for cloud cover to maximize energy capture. A further example of the external devices 200 include devices that the ECU 12 has direct, full access connection, such as the LED lighting devices. For example, the ECU 12 may be configured with direct access to the external device 200 to execute at least one of the actions 40 in response to the detected contextual event 20. Some external devices 200 may be controlled by setting routines 206. The routines 206 may be configured based on the contextual event data 22, which the external device 200 may otherwise not receive or detect independent of the contextual communication feature 18. For example, the routines 206 may include, but are not limited to, opening awnings, deploying extensions, lowering leveling jacks, and/or activating hot water heaters and furnaces.

With further reference to FIGS. 1-3, the ECU 12 monitors for the external devices 200 once the vehicle 100 is in operation. The ECU 12 may detect new external devices 200 and/or detect known external devices 200. For example, the ECU 12 may search for an external device 200 until an external device 200 is detected and connected. Once the external device 200 is detected, the ECU 12 monitors for contextual events 20.

The contextual communication system 10 is configured to determine whether to execute one or more actions 40 based on the contextual event data 22. For example, one or more actions 40 may be available to execute by the ECU 12, and the contextual communication feature 18 determines whether to execute the action(s) 40 based on the contextual event data 22 and action settings 44 of the respective actions 40. In some examples, the ECU 12 may determine that the associated available action 40 has a manual setting 48, such that the contextual communication feature 18 executes the contextual alert 38 rather than automatically executing the action 40. Thus, the user may determine whether to activate the action 40. In some instances, the action(s) 40) may have the automatic setting 46, such that the ECU 12 may automatically execute the action 40. In this example, the ECU 12 may issue a reminder 52 to the user that the ECU 12 has executed an action 40 with an automatic setting 46. The user may adjust the action settings 44 or dismiss the reminder 52.

In other examples, the action(s) 40 may have manual settings 48, such that the user is prompted with the contextual alert 38 to authorize execution of the action 40. The contextual alert 38 notifies the user of the available action 40 to provide the option to execute the action 40. If the user authorizes the action(s) 40, then the external device 200 executes the associated action 40) based on the contextual event data 22. If the user declines the contextual alert 38, then the ECU 12 continues to monitor for contextual events 20 and potentially associated actions 40.

Referring still to FIGS. 1-3, the ECU 12 utilizes the telematics system 32 and the communication receiver 202 of the external device 200 to determine the relative positioning data 42 of the external device(s) 200. The ECU 12 may utilize the relative positioning data 42 pertinent to the respective external devices 200 to define spatial awareness between external devices 200 and/or to implement adjustments to the external device(s) 200. For example, the ECU 12 may be configured to communicate the relative positioning data 42 in combination with the actions 40 to reposition or otherwise identify a displacement of the external device 200. The relative positioning data 42 may thus be utilized in combination with one or more of the actions 40 depending on the external device 200 and the action 40.

In some instances, the contextual communication feature 18 may be configured to issue the contextual alert 38 in response to the detected contextual event 20 instead of prompting an action 40. For example, the contextual communication feature 18 may determine whether the contextual alert 38 is configured for the infotainment display 102 of the vehicle 100 or a user device 300 of the user. The contextual communication feature 18 may push the contextual alert 38 to the user device 300 via a text message and/or an application on the user device 300. The contextual alert 38 may provide the option to the user to adjust the actions 40 and may also include instructions for the user.

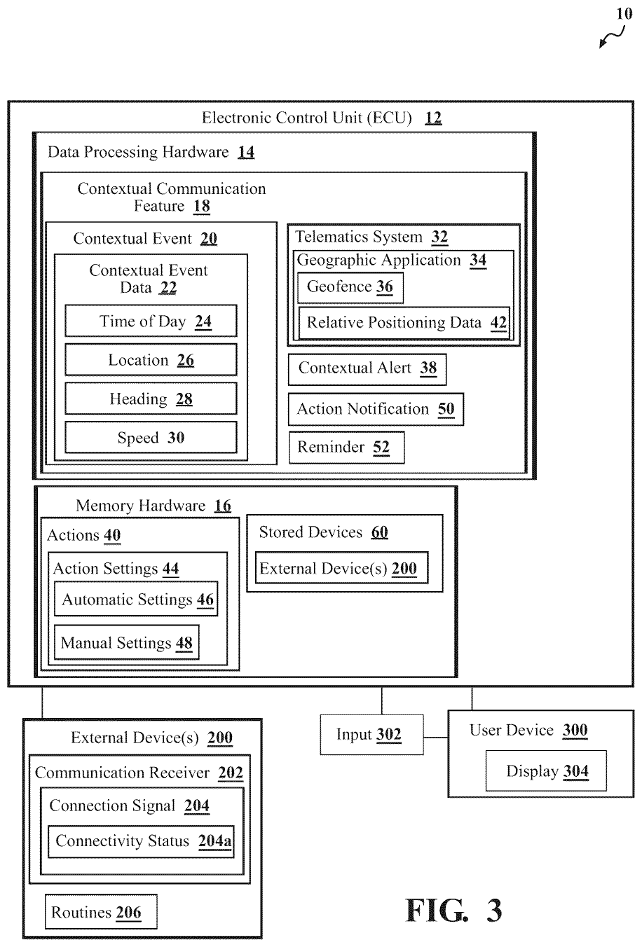

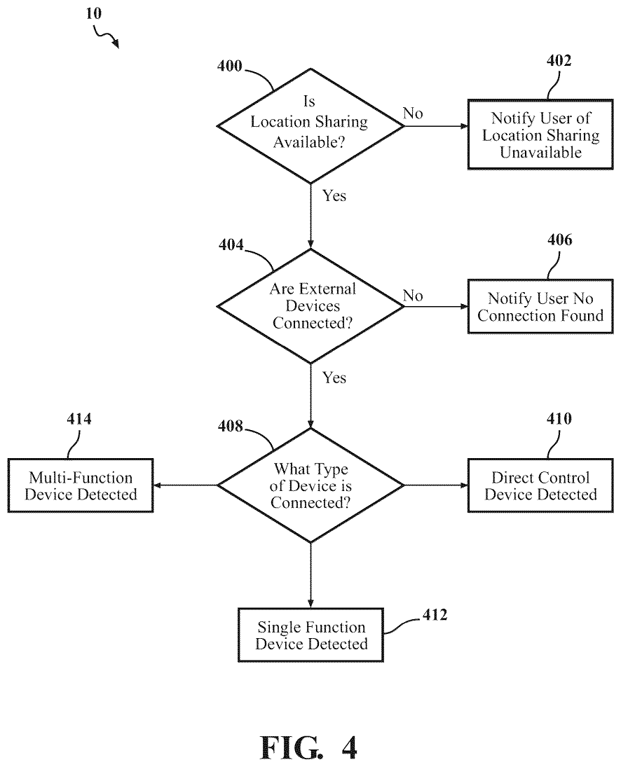

Referring now to FIGS. 3-6, an example flow diagram for the contextual communication system 10 is described. The ECU 12 determines, at 400, whether location sharing is available. If location sharing is not available, the ECU 12 notifies the user, at 402, that location sharing is unavailable. If location sharing is available, the ECU 12 determines, at 404, whether any external devices 200 are connected. If no external devices 200 are connected, the ECU 12, at 406, notifies the user that no connected external devices 200 are detected. If one or more external devices 200 are detected, the ECU 12, at 408, determines what type of external device 200 is connected. For example, the ECU 12 may detect, at 410, a direct control device 200. Optionally, the ECU 12 may detect, at 412, a single-function device 200. In other instances, the ECU 12 may detect, at 414, a multi-function use device 200.

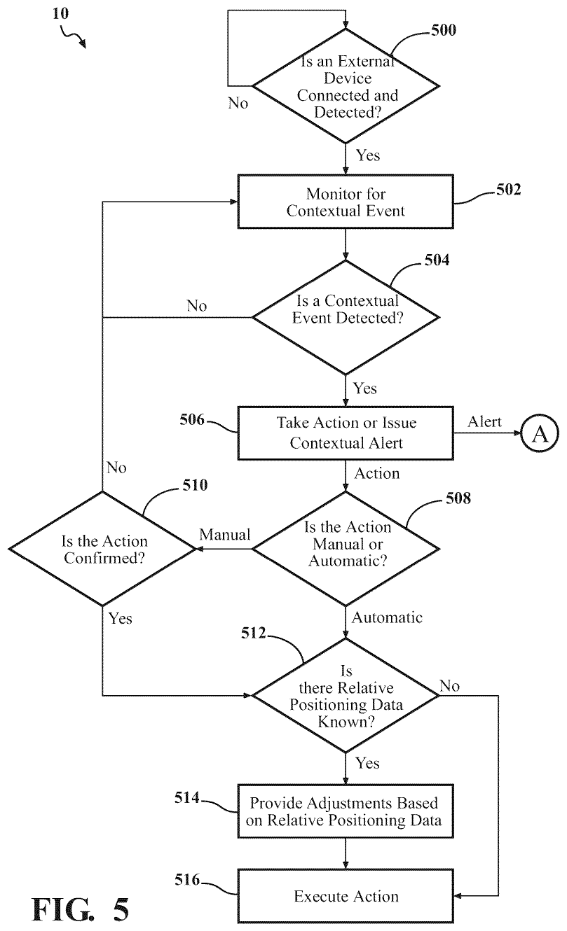

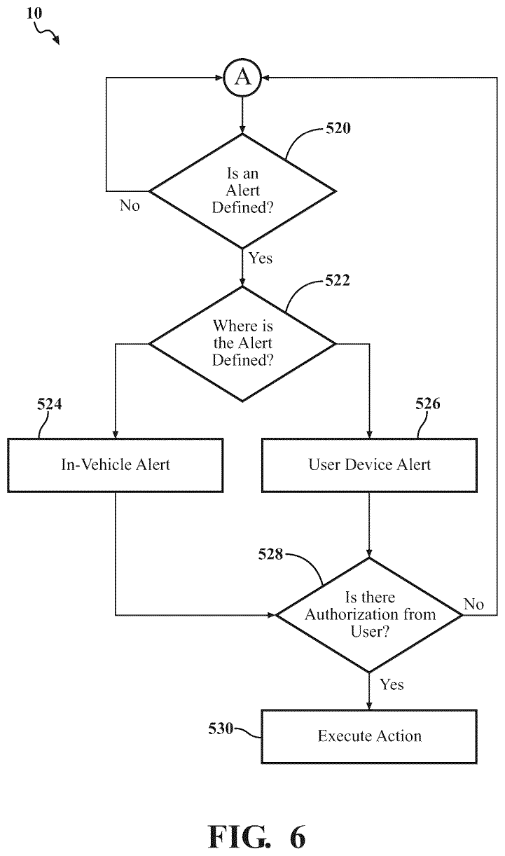

FIGS. 5 and 6 illustrate another example flow diagram for the contextual communication system 10. The ECU 12 determines, at 500, whether an external device 200 is connected and detected. If no external device 200 is detected, then the ECU 12 continues to monitor for any potential connections. If an external device 200 is detected, the ECU 12 monitors, at 502, for contextual events 20. The ECU 12 determines, at 504, whether a contextual event 20 is detected. If no contextual event 20 is detected, the ECU 12 continues to monitor for contextual events 20. If a contextual event 20 is detected, then the ECU 12, at 506, determines whether to execute an action 40 or a contextual alert 38. When executing the action 40, the ECU 12 determines, at 508, whether the action 40 has automatic settings 46 or manual settings 48. If the action 40 has manual settings 48, then the ECU 12 determines, at 510, whether the action 40 was confirmed. If the action 40 is not confirmed, the ECU 12 continues to monitor for other contextual events 20. If the action 40 is confirmed, then the ECU 12 determines, at 512, whether there is relative positioning data 42 known for the external device 200 and the associated action 40. Similarly, if the action 40 has automatic settings 46, then the ECU 12 proceeds with determining whether there is relative positioning data 42 known for the external device 200 and the associated action 40. If there is relative positioning data 42 known, then the ECU 12 provides, at 514, adjustments based on the relative positioning data 42 and executes, at 516, the action 40. If no relative positioning data 42 is known, then the ECU 12 executes, at 516, the action 40.

If the ECU 12 determines, at 506, to execute the contextual alert 38, then the ECU 12 determines, at 520, whether a contextual alert 38 is defined. If the contextual alert 38 is not defined, then the ECU 12 returns to monitoring for contextual events 20. If the contextual alert 38 is defined, then the ECU 12, at 522, determines where the contextual alert 38 is defined. For example, the ECU 12 may determine, at 524, that the contextual alert 38 is defined as an in-vehicle alert. Additionally or alternatively, the ECU 12 may determine, at 526, that the contextual alert 38 is defined as a user device alert. The ECU 12 then determines, at 528, whether there is authorization from the user. If there is authorization from the user, then the ECU 12, at 530, executes the action 40.

Referring again to FIGS. 1-6, the contextual communication system 10 advantageously interconnects multiple external devices 200 with the vehicle 100 and/or the user device 300 via the contextual communication feature 18. The contextual communication feature 18 shares the contextual event data 22 with the external devices 200 to assist the external devices 200 in executing actions 40 based on detected contextual events 20. The external devices 200 may, in effect, utilize the telematics system 32 of the contextual communication feature 18 to navigate the various actions 40 and utilize the contextual event data 22 that may otherwise be unavailable. Further, the use of the short range wired or wireless connection between the contextual communication feature 18 and the external devices 200 minimizes the energy consumption to provide the contextual event data 22 and execute the various associated actions 40. Thus, the contextual communication system 10 maximizes the performance and connectivity between vehicles 100 and associated external devices 200.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A contextual communication system comprising:
an external device including a communication receiver; and
an electronic control unit (ECU) including data processing hardware and memory hardware storing actions and action settings, the data processing hardware including a contextual communication feature having a telematics system configured to detect the external device and a contextual event, the contextual communication feature being configured to selectively issue a contextual alert based on the detected external device and in response to the contextual event.

2. The contextual communication system of claim 1, wherein the actions are associated with the external device and the contextual communication feature is configured to execute the actions based on contextual event data corresponding to the detected contextual event.

3. The contextual communication system of claim 1, wherein the action settings stored in the memory hardware include automatic settings and manual settings, each action being configured with one of the automatic settings and the manual settings.

4. The contextual communication system of claim 3, wherein the contextual communication feature is configured to automatically execute the actions configured with the automatic settings in response to the detected contextual event.

5. The contextual communication system of claim 3, wherein the contextual communication feature is configured to issue an action notification associated with actions configured with the manual settings.

6. The contextual communication system of claim 1, wherein the telematics system includes a geographic application and a geofence, the contextual communication feature being configured to detect the communication receiver of the external device using at least one of the geographic application and the geofence.

7. The contextual communication system of claim 1, wherein the ECU is configured with direct access to the external device to execute at least one of the actions in response to the detected contextual event.

8. The contextual communication system of claim 1, wherein the telematics system is configured to detect the external device via the communication receiver, the contextual communication feature being configured to utilize contextual event data corresponding to the contextual event to execute at least one action associated with the detected external device.

9. A vehicle including the contextual communication system of claim 1.

10. A contextual communication system for a vehicle, the contextual communication system comprising:
an external device including a communication receiver configured to share a connectivity status of the external device:
memory hardware storing actions and action settings including at least one of automatic settings and manual settings:
a geographic application configured to detect a location of the vehicle; and
data processing hardware communicatively coupled with the memory hardware and the geographic application and including a contextual communication feature configured to detect a contextual event and including a telematics system communicatively coupled with the geographic application and configured to detect the connection status of the external device, the contextual communication feature being configured to selectively execute one or more of the actions in response to the detected connectivity status of the external device and the contextual event.

11. The contextual communication system of claim 10, wherein the contextual communication feature is configured to execute the actions based on contextual event data corresponding to the detected contextual event.

12. The contextual communication system of claim 11, wherein the contextual event data includes one or more of a time of day, the location of the vehicle, a heading of the vehicle, and a speed of the vehicle.

13. The contextual communication system of claim 12, wherein the contextual communication feature is configured to issue an action notification associated with the actions configured with the manual settings and is configured to execute the one or more actions in response to an input at the action notification.

14. The contextual communication system of claim 12, wherein the contextual communication feature is configured to issue a reminder associated with the automatic settings in response to the detected contextual event.

15. The contextual communication system of claim 10, wherein the contextual communication feature is configured to automatically execute at least one of the one or more actions based on the location of the vehicle from the geographic application.

16. The contextual communication system of claim 10, wherein the data processing hardware is configured with direct access to the external device to execute at least one of the one or more actions.

17. The contextual communication system of claim 10, wherein the external device is configured with a multi-function use and the contextual communication feature is configured to utilize contextual event data corresponding to the detected contextual event to execute at least one of the one or more actions based on the multi-function use of the external device.

18. The contextual communication system of claim 17, wherein the contextual communication feature is configured to utilize the telematics system to cooperate with the geographic application to identify an action associated with the multi-function use.

19. A vehicle including the contextual communication system of claim 10.

20. A system comprising:
at least one external device including a communication receiver configured for sharing data of the at least one external device:
a user device; and
a vehicle including an electronic control unit (ECU) communicatively coupled to the communication receiver of the at least one external device and the user device, the ECU including a contextual communication feature configured to detect a contextual event and configured to execute an action in response to the detected contextual event, the user device being configured to receive a contextual alert from the contextual communication feature in response to the contextual event associated with the action.
